(19) United States
(12) Patent Application Publication
(10) Pub. No.: US 2013/0044054 A1
(43) Pub. Date: Feb. 21, 2013

(54) METHOD AND APPARATUS FOR PROVIDING BARE-HAND INTERACTION

(71) Applicants: Dong Woo LEE, Daejeon (KR); Hyun Tae Jeong, Daejeon (KR); Hee Sook Shin, Daejeon (KR); Jeong Mook Lim, Daejeon (KR); Sungyong Shin, Daejeon (KR); Yong Ki Son, Daejeon (KR); IL Yeon Cho, Daejeon (KR); Jun Seok Park, Daejeon (KR)

(72) Inventors: Dong Woo LEE, Daejeon (KR); Hyun Tae Jeong, Daejeon (KR); Hee Sook Shin, Daejeon (KR); Jeong Mook Lim, Daejeon (KR); Sungyong Shin, Daejeon (KR); Yong Ki Son, Daejeon (KR); IL Yeon Cho, Daejeon (KR); Jun Seok Park, Daejeon (KR)

(73) Assignee: ELECTRONICS AND TELECOMMUNICATIONS RESEARCH INSTITUTE of Daejeon, Daejeon (KR)

(21) Appl. No.: 13/588,019

(22) Filed: Aug. 17, 2012

(30) Foreign Application Priority Data
Aug. 19, 2011 (KR) 10-2011-0082921

(51) Int. Cl. G06F 3/033

(52) U.S. Cl. 345/158; 345/156

(57) ABSTRACT

An apparatus for providing bare-hand interaction includes a pattern image projecting unit for projecting a pattern image of structured light onto a projection zone and an image projection unit for projecting an image of digital contents onto a projection zone. The pattern image is captured from the projection zone by a pattern image capturing unit and processed by an image recognizing unit in order to recognize a user input interacted with the projected contents image. The apparatus then generate a system event corresponding to the recognized user input to control an application program in accordance with the event.

### RELATED APPLICATION(S)

This application claims the benefit of Korean Patent Application No. 10-2011-0082921, filed on Aug. 19, 2011, which is hereby incorporated by references as if fully set forth herein.

### FIELD OF THE INVENTION

The present invention relates to an apparatus and method for providing bare-hand interaction, and more particularly, to an apparatus of a system for providing bare-hand interaction having an integrated projector and camera, and a method of providing bare-hand interaction using the same.

### BACKGROUND OF THE INVENTION

With the recent development of technologies, projectors and cameras have been increasingly reduced in size enough to be mounted in mobile devices. A wearable system is conceptually proposed to fabricate a projector and a camera in a wearable type to provide various services, for example, the SixthSense, by Massachusetts Institute of Technology (MIT), and an interaction system of a portable type has been developed that may be carried to be used, for example, Mobile Surface available from Microsoft Corporation or Light Touch™ available from Light Blue Optics. Of course, the use of such systems allows for expressing of digital information on a realistic object, rather than on a screen of a digital terminal and creating new services as well.

In order for such systems to be conveniently used, an interaction method using bare hands is required to be provided. In addition, a way of fabricating the systems to have a small load and size at low costs so as to be quickly used in an embedded system is also required to be provided.

An existing image recognition technique is mainly related to a technique of recognizing human faces, gestures or the like through complicated algorithms by using a color camera. Such techniques require a very fast computer and are inappropriate to a small product like an embedded system. In particular, tracking a movement of a hand or recognizing a gesture in a projected image from a projector is different from simply recognizing an image by using only a camera without the projected image.

In a projector-based environment, however, the method needs to project an output image onto an object such as a hand, which results in drastically degrading a recognition rate, and also, since a light source is severely changed, recognition itself may be impossible.

### SUMMARY OF THE INVENTION

In view of the above, the present invention provides an apparatus and method for providing bare-hand interaction, which is capable of recognizing a user input using a pattern image.

Further, the present invention provides an apparatus and method for providing bare-hand interaction, which is capable of quickly processing a change in the pattern image so as to be applicable to an embedded system having a low system specification.

The objects of the invention are not limited thereto, but other objects that are not described above will be apparently understood by those skilled in the art from the following description.

In accordance with an aspect of the present invention, there is provided an apparatus for providing bare-hand interaction, which includes: a pattern image projecting unit for projecting a pattern image of structured light onto a projection zone; an image projection unit for projecting an image of digital contents onto a projection zone; a pattern image capturing unit for capturing the pattern image from the projection zone; an image recognizing unit for processing the captured pattern image to recognize a user input interacted with the projected contents image; and an event generating unit for generating a system event corresponding to the recognized user input to control an application program in accordance with the event.

In the embodiment, the pattern image projecting unit includes: a laser for generating an infrared (IR) laser beam; and a diffraction grating for diffracting the laser beam to generate the pattern image of structured light.

In the embodiment, the pattern image is invisible to a user not to interfere with the visibility of the digital content images projected on the projection zone, and has a pattern such as stripes, lines, or points in order to easily recognize the change in the pattern image. The pattern has code values corresponding to stripes, lines, or points.

In the embodiment, the pattern image capturing unit includes an IR camera for capturing the pattern image from the projection zone.

In the embodiment, the apparatus further includes a visible image capturing unit for capturing a visible image including the contents image from the projection zone, and the image recognizing unit further recognizes contents in the captured visible image on which a user interaction has been performed.

In the embodiment, the image recognizing unit detects the changes of position, shape and brightness of the pattern in the captured pattern image to recognize the user input corresponding to the change in the captured pattern image.

In the embodiment, the system event includes a mouse event.

In accordance with another aspect of the present invention, there is provided a method for providing bare-hand interaction, including: projecting a pattern image of structured light onto a projection zone; projecting an image of digital contents onto the projection zone; capturing the pattern image from the projection zone; detecting the change in the captured pattern image; recognizing a user input interacted with the projected contents image based on the detected change in the captured pattern image; and generating a system event corresponding to the recognized user input to control an application program in accordance with the system event.

In the embodiment, the projecting a pattern image of structured light includes: generating an infrared (IR) laser beam; and diffracting the laser beam to generate the pattern image of structured light.

In the embodiment, the method further includes capturing a visible image including the content image from the projection zone to recognize contents in the captured visible image on which a user interaction has been performed.

In the embodiment, the pattern image has a pattern such as stripes, lines, or points in order to easily recognize the change in the pattern image.

In the embodiment, the detecting the change in the captured pattern image includes detecting the changes of position, shape and brightness of the pattern in the pattern image.

In the embodiment, the system event includes a mouse event.

### BRIEF DESCRIPTION OF THE DRAWINGS

The above and other objects and features of the present invention will become apparent from the following description of embodiments, given in conjunction with the accompanying drawings, in which:

FIG. 1A is a perspective view of an apparatus of a stand type for providing bare-hand user interaction in accordance with an embodiment of the present invention;

FIG. 1B is a bottom view of the apparatus for providing bare-hand interaction illustrated in FIG. 1A, viewed in a lower surface thereof along an arrow;

FIG. 2 illustrates a block diagram of the apparatus for providing bare-hand interaction illustrated in FIGS. 1A and 1B in accordance with an embodiment of the present invention;

FIG. 3 illustrates a pattern image generated by a pattern image generation unit shown in FIG. 2;

FIG. 4 illustrates the change in the pattern illustrated in FIG. 3, which is caused by a hand gesture; and

FIG. 5 is a flowchart illustrating a method for providing bare-hand interaction using the apparatus shown in FIGS. 1A and 1B in accordance with an embodiment of the present invention.

### DETAILED DESCRIPTION OF THE EMBODIMENTS

Hereinafter, an embodiment of the present invention will be described in detail with the accompanying drawings.

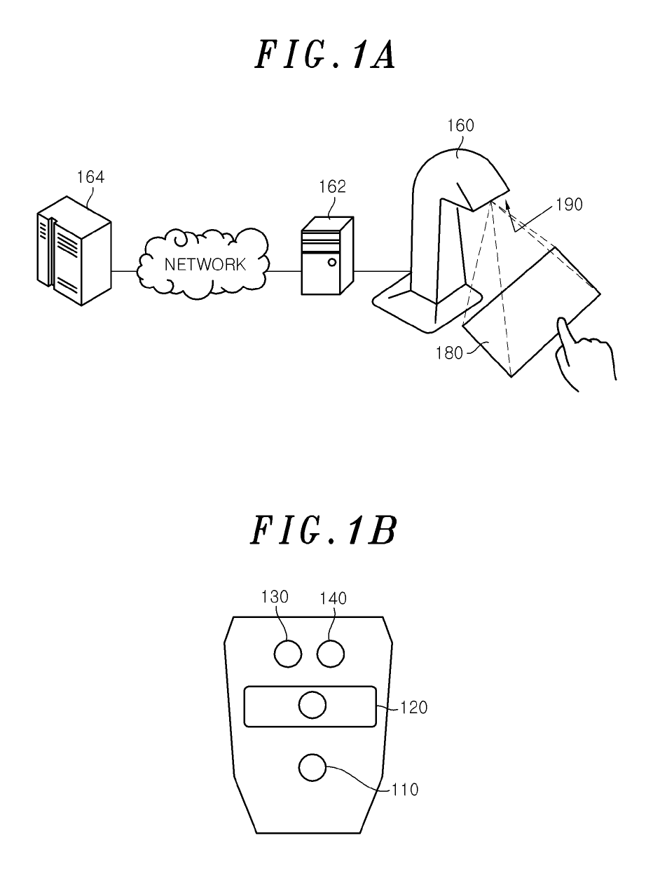

FIG. 1A is a perspective view of an apparatus for providing bare-hand interaction in accordance with an embodiment of the present invention.

An apparatus 160 for providing bare-hand interaction is designed in a stand type or a desk-top type in which an integrated projector and camera is installed. The apparatus 160 is configured to project an image of corresponding digital contents in a local system 162 or a remote contents server 164 along with an invisible pattern image onto a certain space, e.g., a projection zone 180 on a surface of, e.g., a desk, a table, a wall surface or the like. The apparatus 160 then recognizes a user input interacted with the projected digital contents image in order to generate an event of a user input. The user input may include touch/drag/release or the like with his/her fingers performed on the projected digital contents image, which may cause the change in the pattern image. The apparatus 160 then recognizes the user input as, for example, a mouse event, a gesture, a posture, or the like.

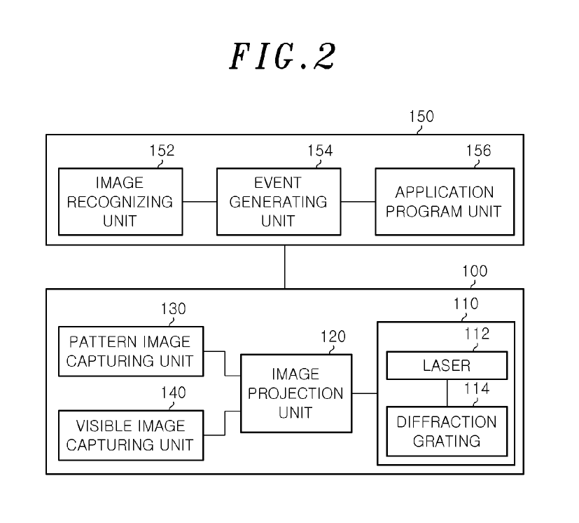

FIG. 2 illustrates a block diagram of the apparatus for providing bare-hand interaction illustrated in FIGS. 1A and 1B in accordance with an embodiment of the present invention.

As shown in FIG. 2, the apparatus for providing bare-hand interaction may generally include an image controlling module 100 and an application controlling module 150. The image controlling module 100 includes a pattern image projecting unit 110, an image projection unit 120 such as an image projector, a pattern image capturing unit 130, and a visible image capturing unit 140. The application controlling module 150 includes an image recognizing unit 152, an event generating unit 154, and an application program unit 156.

The image projection unit 120 projects an image of digital contents onto a projection zone 180 on a surface of, e.g., a desk, a table, a wall surface or the like. The image projection unit 120 may be, for example, an image projector.

The pattern image projecting unit 110 projects a pattern image of structured light onto a projection zone 180. The pattern image projecting unit 110 includes a laser 112 for generating an IR (infrared) laser beam and a diffraction grating 114 for diffracting the IR laser beam to generate the pattern image of structured light. The pattern image is invisible to a user and therefore does not interfere with the visibility of the digital content images projected on the projection zone 180.

The pattern image may be a pattern image 300 of a structured light with a form of a stripe pattern 300 as shown in FIG. 3. The pattern image may have a pattern such as stripes, lines, or points in order to easily recognize the change in the pattern image 300. The pattern may have code values corresponding to stripes, lines, or points.

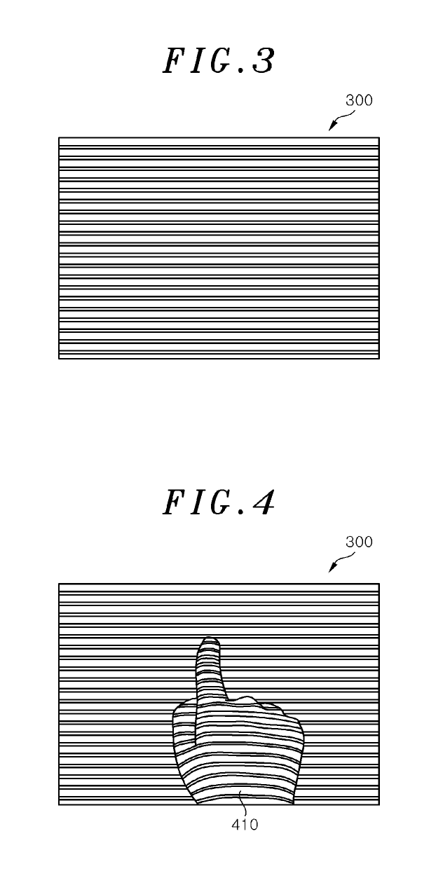

FIG. 4 illustrates the change in the pattern image 300 illustrated in FIG. 3. In FIG. 4, when the image of digital contents projected onto the projection zone 180 along with pattern image 300 is touched by the user's hand 410 or a user's finger, the touch may cause the change in the pattern image 300. That is, the pattern image 300 is changed by a gesture of a user's hand or user's finger performed on the pattern image 300. The change may be recognized as the user input such as a mouse event.

The pattern image capturing unit 130 captures a pattern image from the projection zone 180 and then provides the captured pattern image to the image recognizing unit 152 of the application controlling module 150. The pattern image capturing unit 130 may be implemented as, for example, an IR camera.

The visible image capturing unit 140 captures a visible image including the projected digital contents image from the projection zone 180 or a book, an object or the like positioned on the projection zone 180, and provides the captured visible image to the image recognizing unit 152 of the application controlling module 150. For example, the visible image capturing unit 140 may be implemented, for example, by using an RGB camera.

In the application controlling module 150, the image recognizing unit 152 processes the visible image captured by the visible image recognizing unit 140 to recognize contents on which a user performs a hand gesture or interaction, such as texts, letters and objects printed on a book or the like in the captured contents image.

Further, the image recognizing unit 152 processes the captured pattern image to recognize a user input interacted with the contents in the visible image by detecting the change in the captured pattern image by the pattern image capturing unit 130. That is, the image recognizing unit 152 detects a distorted state of the captured pattern image, e.g., the changes of position, shape and brightness in the captured pattern image, thereby recognizing the user input such as user's touch/drag/release or the like based on the change in the pattern image.

The event generating unit 154 generates a variety of system events based on the recognized user input to execute the apparatus 160 in accordance with a command corresponding to the recognized user input.

The application program unit 156 is controlled based on the event generated by the event generating unit 154 to provide various services. The service may includes, for example, a presentation service for providing a description of a word on which a user's interaction has been performed, and a keeping service for saving a portion of an image on which a user's interaction has been performed.

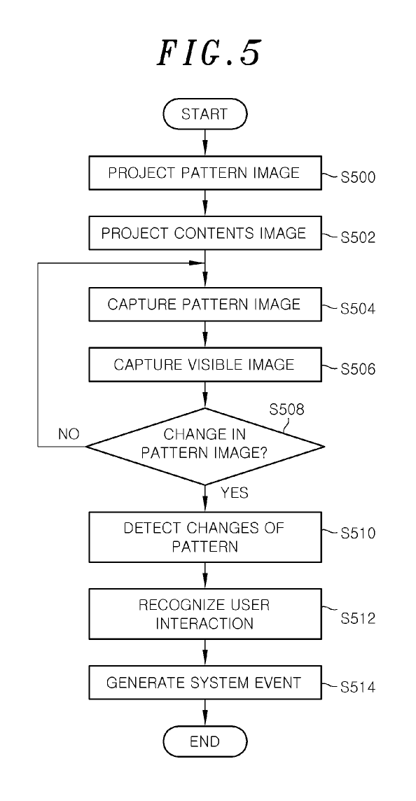

FIG. 5 is a flowchart illustrating a method for providing bare-hand interaction using the apparatus shown in FIGS. 1A and 1B in accordance with an embodiment of the present invention.

As shown in FIG. 5, the pattern image projecting unit 110 projects the pattern image of structured light by using the laser 112 and the diffraction grating 114 in step S500 onto the projection zone 180.

The image projection unit 120 projects the digital contents image onto the projection zone 180 in step S502.

Thereafter, in step S504, the pattern image capturing unit 130 captures the pattern image from the projection zone 180, and then provides the captured contents image to the image recognizing unit 152.

In step S506, the visible image capturing unit 140 captures the visible image including the digital contents image from the projection zone 180, and then provides the captured visible image to the image recognizing unit 152.

The image recognizing unit 152 then recognizes the contents on which a user interaction has been performed from the captured visible image. Further, the image recognizing unit 152 detects one or more of the changes of position, shape and brightness in the captured pattern image.

In step S508, the image recognizing unit 152 determines whether or not there is the change in the captured pattern image due to the user interaction.

When the user input is recognized based on the determination result in step S508, the image recognizing unit 152 detects the changes of the pattern in the captured pattern image in step S510 to recognize a user input corresponding to the user interaction in step S512. The recognized user input is then provided to the event generating unit 154.

The event generating unit 154 then generates a system event corresponding to the user input to provide the event to the application program unit 156 in step S514.

The application program unit 156 is controlled based on the system event generated by the event generating unit 154 to provide various services in step S512.

In accordance with the present invention, the image recognition, which may not be easily made by a conventional image recognition method under a projected image, can be quickly and easily performed by using a structured pattern image, and a user's finger touch or finger gesture can be precisely recognized using the structured pattern image.

Further, in accordance with the embodiment, since a structured pattern image is used, fast image recognition can be performed by a smaller amount of calculation, and thus, the embodiment can be advantageously applied to an embedded system having a low system specification.

While the invention has been shown and described with respect to the embodiments, the invention is not limited thereto. It will be understood by those skilled in the art that various changes and modifications may be made without departing from the scope of the invention as defined in the following claims.

What is claimed is:

1. An apparatus for providing bare-hand interaction, comprising:
a pattern image projecting unit for projecting a pattern image of structured light onto a projection zone;
an image projection unit for projecting an image of digital contents onto a projection zone;
a pattern image capturing unit for capturing the pattern image from the projection zone;
an image recognizing unit for processing the captured pattern image to recognize a user input interacted with the projected contents image; and
an event generating unit for generating a system event corresponding to the recognized user input to control an application program in accordance with the event.

2. The apparatus of claim 1, wherein the pattern image generating unit includes:
a laser for generating an infrared (IR) laser beam; and
a diffraction grating for diffracting the laser beam to generate the pattern image of structured light.

3. The apparatus of claim 2, wherein the pattern image is invisible to a user not to interfere with the visibility of the digital content images projected on the projection zone.

4. The apparatus of claim 2, wherein the pattern image has a pattern such as stripes, lines, or points in order to easily recognize the change in the pattern image.

5. The apparatus of claim 4, wherein the pattern has code values corresponding to stripes, lines, or points.

6. The apparatus of claim 1, wherein the pattern image capturing unit includes an IR camera for capturing the pattern image from the projection zone.

7. The apparatus of claim 1, further comprising:
a visible image capturing unit for capturing a visible image including the contents image from the projection zone,
wherein the image recognizing unit further recognizes contents in the captured visible image on which a user interaction has been performed.

8. The apparatus of claim 4, wherein the image recognizing unit detects the changes of position, shape and brightness of the pattern in the captured pattern image to recognize the user input corresponding to the change in the captured pattern image.

9. The apparatus of claim 1, wherein the system event includes a mouse event.

10. A method for providing bare-hand interaction, comprising:
projecting a pattern image of structured light onto a projection zone;
projecting an image of digital contents onto the projection zone;
capturing the pattern image from the projection zone;
detecting the change in the captured pattern image;
recognizing a user input interacted with the projected contents image based on the detected change in the captured pattern image; and
generating a system event corresponding to the recognized user input to control an application program in accordance with the system event.

11. The method of claim 10, wherein said projecting a pattern image of structured light includes:
generating an infrared (IR) laser beam; and
diffracting the laser beam to generate the pattern image of structured light.

12. The method of claim 10, further comprising capturing a visible image including the content image from the projection zone to recognize contents in the captured visible image on which a user interaction has been performed.

13. The method of claim 11, wherein the pattern image has a pattern such as stripes, lines, or points in order to easily recognize the change in the pattern image.

14. The method of claim 13, wherein said detecting the change in the captured pattern image includes:
detecting the changes of position, shape and brightness of the pattern in the pattern image.

15. The method of claim 10, wherein the system event includes a mouse event.
